(19) United States
(12) Patent Application Publication
(10) Pub. No.: US 2015/0222124 A1
(43) Pub. Date: Aug. 6, 2015

(54) METHOD AND UNIT OF POWER HARVESTING

(71) Applicant: AKTIEBOLAGET SKF, Göteborg (SE)

(72) Inventors: Gertjan Van Amerongen, Scherpenzeel (NL); Andreas Clemens Van Der Ham, Utrecht (NL)

(21) Appl. No.: 14/395,501

(22) PCT Filed: Apr. 24, 2013
(86) PCT No.: PCT/EP2013/058444

§ 371 Date: Dec. 17, 2014

Related U.S. Application Data
(60) Provisional application No. 61/637,475, filed on Apr. 24, 2012.

(51) Int. Cl. H02J 4/00; G05B 15/02

(52) U.S. Cl. CPC H02J 4/00; G05B 15/02

(57) ABSTRACT

An electrical solution that avoids power-up problems due to excessive power consumption during start-up of for example microcontroller based electronics. According to the invention the power consuming electronics is disconnected from a power supply until all power storage elements of the power supply are charged up to a first predetermined level. The power consuming electronics will also be disconnected when the available energy falls under a second predetermined value. This behaviour is useful when all energy is harvested from a weak energy source and the attached power consuming electronics does not work continuously.

### CROSS REFERENCE TO RELATED APPLICATIONS

This is a National Stage application claiming the benefit of International Application Number PCT/EP2013/058444 filed on 24 Apr. 2013 (27.03.2013), which claims the benefit of U.S. Provisional Patent Application No. 61/637,475 filed on 24 Apr. 2012, both of which are incorporated herein by reference in their entireties.

### TECHNICAL FIELD

The invention concerns power harvesting and is more particularly directed to power harvesting control during start-up.

### BACKGROUND

Autonomous power harvesters are normally weak voltage sources and have a high impedance. They can normally deliver constant power on a low level. They are not designed to support power consuming electronics with high peak power requirements. A very sensitive peak power requirement is at start-up/power-up. At system start-up there are usually self tests and housekeeping tasks that have to be performed before regular operation is started or resumed. It is important that these self tests and housekeeping tasks can be finished.

Autonomous power harvesters are used to generate energy from a physical effect or principal. Output is mostly an AC or DC voltage and ideally the output voltage will be constant. However, the voltage/current levels generated are not constant and largely depend on what the power harvester is harvesting energy from, how stable this energy source is and the physical effect used. If for example an energy harvester is a generator attached to an axel of a wind turbine, the speed of the axel will depend on the wind blowing and thus vary. If the speed of the axel varies, then the speed of the attached generator will vary as well, causing the output of the generator to vary. As a result the amount of harvested energy varies over time making it difficult to properly start-up an attached system.

There seems to be room for improvement.

### SUMMARY

An object of the invention is to define a method and a unit that provides a solution allowing to manage available/stored energy to avoid power supply breakdowns during start-up that is periods where a power consumption peak occurs and the following low level power consumption that occurs afer power-up. This is accomplished by means of a hysteresis based start-up.

According to the invention an electrical solution is provided that avoids power-up problems due too excessive power consumption during start-up of for example microcontroller based electronics. According to the invention the power consuming electronics is disconnected from a power supply until all power storage elements of the power supply are charged up to a first predetermined level. The power consuming electronics will also be disconnected when the available energy falls under a second predetermined value. This behaviour is useful when all energy is harvested from a weak energy source and the attached power consuming electronics does not work continuously.

From start-up, the electronics waits until the storage components have been charged to provide enough energy, a first predetermined level, for, for example, the initialisation of the micro-controller and its surrounding circuits. Then the power is switched on. As long as the voltage in the storage components is sufficiently high (high enough to run the micro-controller, which is lower than the first predetermined level), the power stays switched on. After the storage is drained, goes below a second predetermined level, the circuit switches off and starts again from the beginning by charging again the storage components. The application is usually combined with a “power good” indication, such that the micro-controller can run its functions when there is sufficient energy to run them.

An alternative would be to wait until the power harvesting source is delivering a sufficient amount of power to allow the micro-controller to start-up. The disadvantage is that the circuit does not have as large an operating range as with the hysteresis circuit.

Start-up: During start-up connected electronics will be disconnected from power harvester and all energy can be used to charge storage devices (capacitors).

Power-peak: During power peaks surplus energy is drawn from storage devices. By measuring supply voltage level it is possible to calculate and optimize power consumption.

Other power sources in parallel: Design can also operate with other power sources in parallel and will not be charged backward.

For all energy harvesting systems, where amount of available energy from harvester is lower then required peak power of attached electronics.

The aforementioned object is achieved according to the invention by a power management system comprising a power switch arranged to regulate power from a power harvester and energy storage means to power consuming circuits. According to the invention the system further comprises an energy storage level determining means arranged to control the power switch. The energy storage level determining means is also arranged to receive or measure an indicator or level of the energy storage level of the energy storage means. Depending on the energy storage level the energy storage level determining means controls the power switch so that either the energy storage means has a connection with the power consuming circuits or not. The energy storage level determining means creates a hysteresis control of the power switch by the use of two different predetermined levels that are compared with the energy storage level.

Suitably if the energy storage level of the energy storage means is equal to or larger than a first predetermined level, then the power switch is turned on to connect the energy storage means with the power consuming circuits.

Also suitably if the energy storage level of the energy storage means is equal to or less than a second predetermined level, then the power switch is turned off to disconnect the energy storage means with the power consuming circuits.

The first predetermined level is preferably higher than the second predetermined level.

The different additional enhancements of the power management system according to the invention can be combined in any desired manner as long as no conflicting features are combined.

The aforementioned object is also achieved according to the invention by a method of managing power to power consuming circuits. According to the invention it is determined if the energy storage means is charged to or above a first predetermined value or not. If it is determined that the energy storage means has been charged to or above the first predetermined level, then power is turned on to the power consuming circuits. The first predetermined level is a level of energy in the energy storage means that is enough for the power surge of a complete start-up of the power consuming circuits.

Suitably the method further determines if the energy storage means is charged to or below a second predetermined value. If it is determined that the energy storage means is charged to or below the second predetermined level, the power to the power consuming circuits is turned off. The second predetermined level is a minimum energy level required by the power consuming circuits for proper functioning after the power-on sequence is done.

Suitably the method also gives a signal to the power consuming circuits before the power is turned off. This to ensure the possibility of a proper shutdown sequence being executed before power is removed.

Preferably the first predetermined level is higher than the second predetermined level.

The different additional enhancements of the method according to the invention can be combined in any desired manner as long as no conflicting features or steps are combined.

Other advantages of this invention will become apparent from the detailed description.

### BRIEF DESCRIPTION OF THE DRAWINGS

The invention will now be described in more detail for explanatory, and in no sense limiting, purposes, with reference to the following figures, in which

FIG. 1 illustrates a flow diagram of the basic principle according to the invention,

FIG. 2 illustrates a block diagram of an embodiment according to the invention,

FIG. 3 illustrates a circuit example of an embodiment according to the invention.

### DETAILED DESCRIPTION

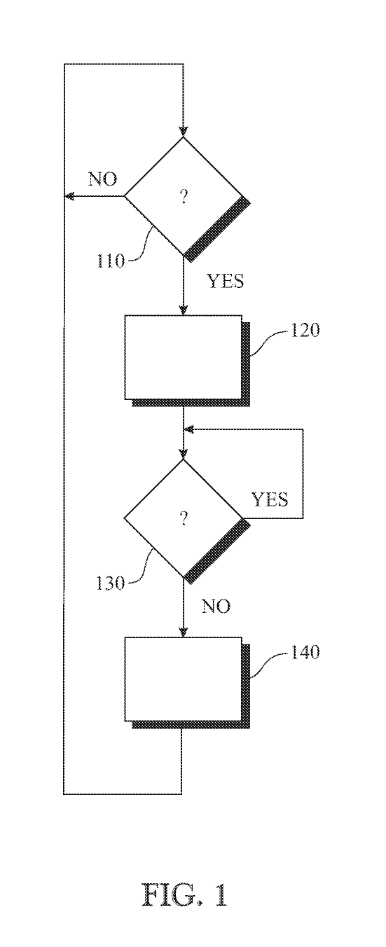

In order to clarify the method and device according to the invention, some examples of its use will now be described in connection with FIGS. 1 to 3.

FIG. 1 illustrates a flow diagram of the basic principle according to the invention. In a first step 110 it is determined if the energy storage means is charged to or above a first predetermined value, if it is not, then it is returned to the first step 110. On the other hand, if it is determined in the first step 110 that the energy storage means has been charged to or above the first predetermined level, in a second step 120, power is turned on to the power consuming circuits. The first predetermined level is a level of energy in the energy storage means that is enough for the power surge of a complete start-up of the power consuming circuits.

In a third step 130, after the second step 120, it is determined if the energy storage means is charged to or below a second predetermined value, if not, then return to the third step 130. On the other hand, if it is determined in the third step 130 that the energy storage means is charged to or below the second predetermined level, the process continues to a fourth step 140, where the power to the power consuming circuits is turned off. The process then returns to the first step 110. The second predetermined level is a minimum energy level required by the power consuming circuits for proper functioning after the power-on sequence is done. In some embodiments there is a signal given to the power consuming circuits before the power is turned off, this to ensure the possibility of a proper shutdown sequence being executed before power is removed.

The energy storage means will be charged by the power harvesting, most likely also during the power-on sequence, ensuring functioning of the power consuming circuits after start-up. In some embodiments the first predetermined level will ensure not only a proper start-up but also a limited further energy for the power consuming circuits.

According to the invention, the energy storage is charged to a level, the first predetermined level, that ensures a complete power-on, and possible some extra energy, and the power consuming circuits are then left running as long as there is enough energy to ensure fully functional execution of the power consuming circuits, as set by the second predetermined level.

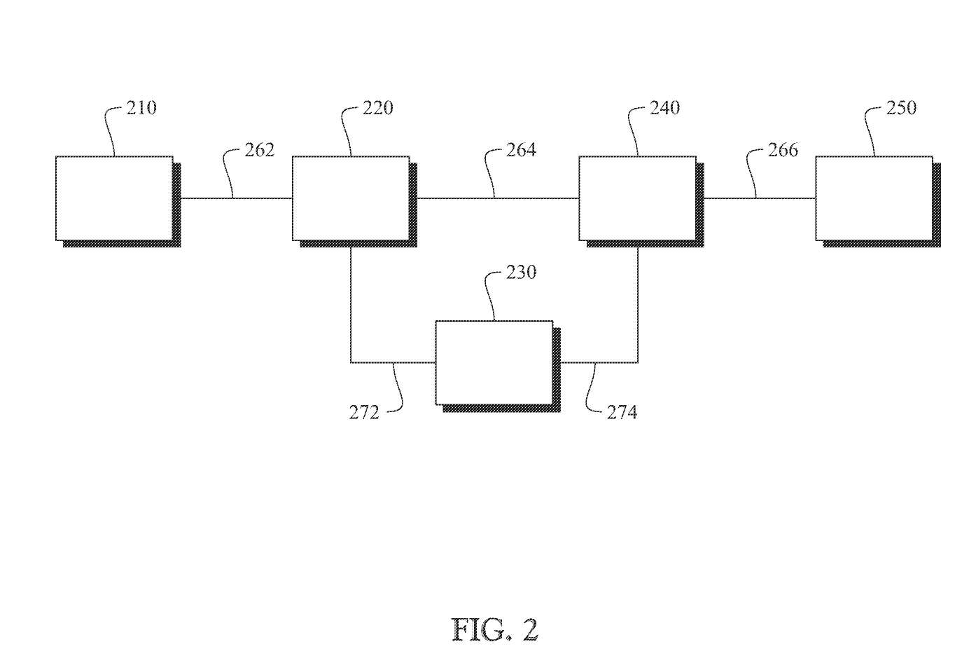

FIG. 2 illustrates a block diagram of an embodiment according to the invention. A power harvester 210 is connected 262 to energy storage means 220. The power harvester 210 will charge the energy storage means 220 either through a continuous trickle charging and/or intermittent charging. The energy storage means 220 is in turn connected 264 to a power switch 240. The power switch 240 is further connected 274 to an energy storage level determining means 230 and also connected 266 to power consuming circuits 250. The power switch 240 either connects or disconnects the energy storage means 220 and the power consuming circuits 250. The energy storage level determining means 230 controls the power switch 240. The energy storage level determining means 230 is also connected to the energy storage means 220 to thereby receive or measure an indicator or level of the energy storage level of the energy storage means 220. Depending on the energy storage level the energy storage level determining means 230 will control the power switch 240 so that either the energy storage means 220 has a connection with the power consuming circuits 250 or not. The energy storage level determining means 230 creates a hysteresis control of the power switch 240 by the use of two different predetermined levels that are compared with the energy storage level. If the energy storage level of the energy storage means 220 is equal to or larger than a first predetermined level, then the power switch 240 is turned on to connect the energy storage means 220 with the power consuming circuits 250. On the other hand, if the energy storage level of the energy storage means 220 is equal to or less than a second predetermined level, then the power switch 240 is turned off to disconnect the energy storage means 220 with the power consuming circuits 250. The first predetermined level is higher than the second predetermined level.

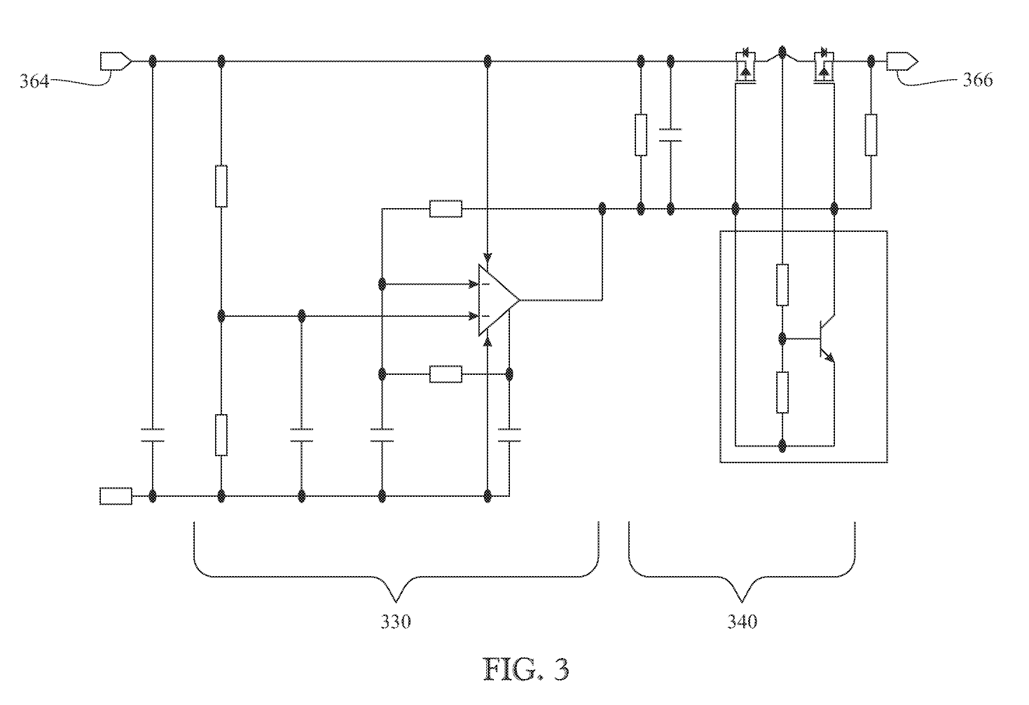

FIG. 3 illustrates a circuit example of an embodiment according to the invention. An energy storage level determining means 330 is connected 364 to energy storage means (not shown), which then via a power switch 340 is connected or disconnected 366 with power consuming circuits (not shown). The energy storage level determining means 330 creates a hysterises based on a first and a second predetermined level, the two levels being different, and thereby controls the power switch 340.

The invention is not restricted to the above-described embodiments, but may be varied within the scope of the following claims.

FIG. 1 illustrates a flow diagram of the basic principle according to the invention:
110 In a first step: Is the energy storage means charged to or above a first predetermined value? If not, then go to the first step,
120 In a second step, if it is determined in the first step that the energy storage means has been charged to or above the first predetermined level: Turn on power to the power consuming circuits,
130 In a third step after the second step: Is the energy storage means charged to or below a second predetermined value?, if not, then return to the third step,
140 In a fourth step, if it is determined in the third step that the energy storage means is charged to or below the second predetermined level: Turn off power to the power consuming circuits, then return to the first step.

FIG. 2 illustrates a block diagram of an embodiment according to the invention:
210 Power harvester,
220 Energy storage means,
230 Energy storage level determining means,
240 Power switch,
250 Power consuming circuits,
262 Power to energy storage means from power harvester,
264 Power from energy storage means to power switch,
266 Power to power consuming circuits from power switch,
272 Indicator of energy storage level to energy storage level determining means,
274 Control signal from energy storage level determining means to power switch.

FIG. 3 illustrates a circuit example of an embodiment according to the invention:
330 Energy storage level determining means,
340 Power switch,
364 Connection to energy storage means,
366 Connection to power consuming circuits.

1. A power management system comprising:
a power switch arranged to regulate power from a power harvester and energy storage device to power consuming circuits, and
an energy storage level determining element arranged to control the power switch, the energy storage level determining element is also arranged to one of receive or measure one of an indicator or level of the energy storage level of the energy storage device, depending on the energy storage level the energy storage level determining element controls the power switch so that one of the energy storage device has a connection with the power consuming circuits or the energy device does not have a connection with the power consuming circuits, the energy storage level determining element creates a hysteresis control of the power switch by the use of two different predetermined levels that are compared with the energy storage level.

2. The power management system according to claim 1, further comprising a step of determining if the energy storage level of the energy storage device is one of equal to or larger than a first predetermined level of the two different predetermined levels, then the power switch is turned on to connect the energy storage device to the power consuming circuits.

3. The power management system according to claim 2, further comprising a step of determining if the energy storage level of the energy storage device is one of equal to or less than a second predetermined level of the two different predetermined levels, then the power switch is turned off to disconnect the energy storage device from the power consuming circuits.

4. The power management system according to claim 3, wherein the first predetermined level is higher than the second predetermined level.

5. A method of managing power to power consuming circuits, comprising a step of determining if the energy storage device is one of charged to or above a first predetermined value or if the energy storage device is not one of charged to or above the first predetermined value,
if it is determined that the energy storage device has been one of charged to or above the first predetermined level, then power is turned on to the power consuming circuits, the first predetermined level is a level of energy in the energy storage device that is enough for the power surge of a complete start-up of the power consuming circuits.

6. The method according to claim 5, further comprising a step of determining if the energy storage device is one of charged to or below a second predetermined value, if it is determined that the energy storage device is one of charged to or below the second predetermined level, the power to the power consuming circuits is turned off, the second predetermined level is a minimum energy level required by the power consuming circuits for proper functioning after the power-on sequence is done.

7. The method according to claim 6, further comprising a step of giving there is a signal to the power consuming circuits before the power is turned off, this to ensure the possibility of a proper shutdown sequence being executed before power is removed.

8. The method according to claim 6, wherein the first predetermined level is higher than the second predetermined level.
